(19) United States
(12) Patent Application Publication
(10) Pub. No.: US 2023/0296163 A1
(43) Pub. Date: Sep. 21, 2023

(54) Selective Motion Transfer Mechanism

(71) Applicant: CBN Nano Technologies Inc., Ottawa (CA)

(72) Inventors: James MacArthur, Manchester (GB); Robert A. Freitas, Jr., Pilot Hill, CA (US); James F. Ryley, III, Downey, CA (US)

(21) Appl. No.: 17/699,732

(22) Filed: Mar. 21, 2022

(51) Int. Cl. F16H 25/04; F16H 37/12

(52) U.S. Cl. CPC F16H 25/04; F16H 37/12

(57) ABSTRACT

A selective motion transfer mechanism acts to transmit rotary motion between a common element and a selected one of multiple channel elements. The common element can be positioned in alignment with any one of the channel elements, and when so aligned, rotation of one of the aligned elements causes rotation of the other.

### CROSS-REFERENCE TO RELATED APPLICATIONS

The present application contains subject matter described in international application PCT/US2021/051411, filed 2021 Sep. 25.

### TECHNICAL FIELD

The present application relates to transmitting rotary motion between a single common element on one side and a selected one of multiple elements on the other side.

### BACKGROUND

Some machines require the transfer of motion between a single, common element and a selected one of multiple elements (considered to represent “channels”). In some cases, a single driver is moved between multiple driven elements to select a particular driven element to be moved at that time, and then engaged with the selected driven element to move it. In other cases, a selected one of multiple drivers is moved to and engaged with a common driven element to drive it at that time. The first cases can be thought of as decoding or demultiplexing in that the mechanism transmits a motion signal from a common input to a selected output channel (the selected driven element), while the second cases can be thought of as encoding or multiplexing, as a motion signal from a selected input channel (the selected driver) is transmitted to a common output.

### SUMMARY

The following Summary is provided to aid in understanding the novel and inventive features set forth in the appended claims, and is not intended to provide a complete description of the inventive features. Thus, any limitations of the following summary should not be interpreted as limiting the scope of the appended claims.

A selective motion transfer mechanism may have a plurality of channel actuators, each of which is rotatable about an associated channel actuator axis, and at least one common actuator that is rotatable about a common actuator axis (to simplify the description, the case where a single common actuator is employed is described throughout, except where noted; it should be appreciated that multiple common actuators could be alternatively employed where a single common actuator is described). The common actuator and the channel actuators are movable with respect to each other such that the common actuator can be placed into alignment opposite a selected one of the channel actuators, forming a pair of aligned elements; this motion could be achieved by moving the common actuator, moving the channel actuators, or a combined movement of both. The common actuator and each of the channel actuators are configured such that, when forming a pair of aligned elements, rotation of one of the aligned elements acts on the other of the aligned elements via non-contact forces to transfer rotational movement thereto. Either the common actuator or the channel actuator in a pair of aligned elements can be rotated by a driver, causing rotation of the other one of the pair of aligned elements. In some cases, each of the channel actuators has a channel actuator engaging portion that extends radially from the channel actuator axis, and the common actuator has a common actuator engaging portion that extends radially from the common actuator axis, with the common actuator engaging portion being superimposable over and substantially parallel to the channel actuator engaging portion of a channel actuator with which the common actuator is currently aligned; in such cases, non-contact forces between the engaging portions serve to transfer motion between the aligned elements to keep them parallel. The selective motion transfer mechanism may be configured such that the common actuator engaging portion and any one of the channel actuator engaging portions can be oriented such that the motion that brings the common actuator into and out of alignment with a particular channel actuator occurs parallel to the common actuator engaging portion and the channel actuator engaging portion. In some cases, the channel actuator axes reside in a common plane. The channel actuator axes can be arranged in a parallel array, in which case the common actuator can translate with respect to the channel actuators along a selection axis to move into and out of alignment with the channel actuators. The channel actuator axes can be arranged in a radial array, in which case the common actuator can rotate with respect to the channel actuators about a central axis to move into and out of alignment with the channel actuators; the channel actuator axes could be arranged in a planar, radial array or in a cylindrical, parallel array. The channel actuators can be rotatably mounted to a body, and the body can have a spacer structure that fills in the spaces between the channel actuators. The common actuator and a channel actuator with which it is currently aligned could be separated by a space of not more than 3 nm. The common actuator and/or channel actuators could have beveled ends to reduce the stiffness of non-contact forces to be overcome to move the common actuator into alignment with a different channel actuator. More than one common actuator could be provided, with the common actuators moving (relatively) as a unit between corresponding sets of channel actuators.

A selective motion transfer mechanism may have a plurality of channel actuators that reside in a planar array, each channel actuator being rotatable about an associated channel actuator axis, and a common actuator, which is rotatable about a common actuator axis and is movable with respect to the channel actuators such that it can be placed into alignment opposite a selected one of the channel actuators, forming a pair of aligned elements with their axes of rotation substantially coincident. The common actuator and each of the channel actuators are configured such that, when the common actuator is aligned with one of the channel actuators, rotation of one of the aligned elements acts on the other of the aligned elements to transfer rotational movement to it. The common actuator and each of the channel actuators are further configured such that they can be brought into and out of alignment by unidirectional movement of the common actuator relative to the channel actuators; this could be rotational motion or translational motion. The relative motion to align the common actuator with a selected channel actuator could be achieved by moving the common actuator, moving the channel actuators, or a combined movement of both. The mechanism has a driver that drives rotation of one of the aligned elements. In some mechanisms, the aligned elements engage each other via non-contact forces. In some mechanisms, the aligned elements engage each other via matching engaging surfaces; such surfaces may be parallel surfaces that extend perpendicular to the actuator axes (when the alignment is achieved through translation), or matching surfaces of rotation (when alignment is achieved through rotational motion). The channel actuator axes may be arranged in a parallel planar array, with the common actuator translating with respect to the channel actuators along a selection axis to move into and out of alignment with the channel actuators. The channel actuators may be arranged in a radial array, with the common actuator rotating with respect to the channel actuators about a central axis to move into and out of alignment with the channel actuators; the channel actuator axes could extend radially with respect to the central axis or could extend parallel to the central axis.

One application for such selective motion-transmitting mechanisms is to convey commands, in the form of rotational motion steps, to multiple controllers for operating a robotic device, thus allowing a single source of rotational motive power to operate a number of control inputs that move parts of the device. Such moving parts could include gears, sprockets, and/or drive screws.

In a method of transferring motion, a plurality of channel actuators (each rotatable about an associated channel actuator axis) and a common actuator (rotatable about a common actuator axis) can be provided. The common actuator can be moved relative to the channel actuators (by motion of the common actuator, motion of the channel actuators, or combined motion of both) to place the common actuator into alignment opposite a selected one of the channel actuators to form a pair of aligned elements. Once the common actuator is so aligned with the desired channel actuator, one of the aligned elements can be rotated, causing rotation of the other of the aligned elements when the common actuator and each of the channel actuators are configured such that rotation of one of the aligned elements acts on the other of the aligned elements via non-contact forces to transfer rotational movement to it. The step of moving the common actuator relative to the channel actuators can include translating the common actuator and/or the plurality of channel actuators along an axis perpendicular to the channel actuator axes, and/or can include rotating the common actuator and/or the plurality of channel actuators about a central axis. Where the motion includes rotation about a central axis, the channel actuator axes could extend perpendicular to the central axis or could extend parallel to the central axis.

### BRIEF DESCRIPTION OF THE FIGURES

FIGS. 1 to 3 illustrate a selective motion transfer mechanism having a common driver translated to align with any one of multiple driven elements, which are arranged in a linear array. When the common driver is aligned with a selected driven element, it drives a common actuator that in turn engages an aligned channel actuator via non-contact forces to rotate the channel actuator.

FIG. 4 illustrates a selective motion transfer mechanism where a common driven element moves between a number of channel drivers that are positioned in a parallel array.

FIG. 5 illustrates a selective motion transfer mechanism in which a linear arrangement of channel drivers is moved to place a selected channel actuator into alignment with a common actuator on a driven element.

FIG. 6 illustrates a selective motion transfer mechanism similar to that shown in FIGS. 1-3, but where the common driver is moved and operated by a belt drive mechanism.

FIGS. 7 and 8 illustrate a selective motion transfer mechanism where a common driver moves between channel driven elements that are positioned in a radial arrangement, having channel actuator axes that are parallel to each other.

FIG. 9 illustrates portions of a selective motion transfer mechanism where channel driven elements are arranged in a planar radial array about a central axis, such that the channel actuators each rotate about a channel actuator axis that intersects and is perpendicular to the central axis.

FIGS. 10 to 12 illustrate a portion of a selective motion transfer mechanism where a common actuator translates along a selection axis between a number of channel actuators, and engages the channel actuators via a tongue-and-groove structure.

FIGS. 13 and 14 illustrate a selective motion transfer mechanism where a common actuator rotates about a central axis to move into alignment with a selected channel actuator, and engages the channel actuators via matching surfaces of rotation about the central axis.

FIGS. 15 to 21 show examples of alternative engaging structures that could be employed for common and channel actuators that engage each other via non-contact force attraction.

FIGS. 22 and 23 illustrate selective motion transfer mechanisms having a common actuator that is movable along two selection axes to align with channel actuators that are arranged in a planar array (a rectangular array in FIG. 22 and a hexagonal array in FIG. 23).

FIGS. 24 and 25 illustrate examples of selective motion transfer mechanisms which moves multiple common drivers between groups of driven elements that define channels, allowing for multiple separate driven elements per channel (three driven elements per channel in FIG. 24, two per channel in FIG. 25).

FIGS. 26 and 27 illustrate two examples of mechanical reduction that can be used to change the angular steps provided by the output of a selective motion transfer mechanism.

### DETAILED DESCRIPTION

The present application incorporates by reference the disclosure of Applicant's pending international application PCT/US2021/051411, entitled Managing Non-Contact Forces in Mechanisms. Such incorporation is only made to the extent that nothing in the earlier application contradicts statements, definitions, and/or characterizations made in the present application.

Selective motion transfer mechanisms have at least one driver, and at least one driven element with which the driver can be engaged, and have at least one common actuator that can be moved relative to a plurality of channel actuators so as to align with a selected one of the channel actuators (such relative movement could be accomplished by moving the common actuator, moving the channel actuators, or combined movement of both). The common actuator could be attached to a driver or to a driven element, and the channel actuators are each attached to the counterparts; that is, where the common actuator is mounted to a driver, a driven element is attached to each of the channel actuators, and where the common actuator is attached to a driven element, a driver is provided for each of the channel actuators. In most examples discussed herein, the common actuator is attached to a driver and is selectively aligned with a selected one of multiple channel actuators attached to driven elements, one for each channel (this situation could be considered as decoding or demultiplexing the motion signal of the driver). However, multiple drivers could be employed attached to the channel actuators, with the common actuator attached to a driven element (which could be considered as encoding or multiplexing the motion signal of the drivers to a common output). Examples that are discussed in terms of one configuration should be considered to also encompass an analogous mechanism where the driver and driven element positions are reversed (i.e., the direction in which motion is transferred is opposite). Note that the interpretation of what portion of a rotating element comprises the “actuator” and what comprises the “driver” or “driven element” is somewhat arbitrary; in practice, the “actuator” may be formed integrally with the “driver” or “driven element”, such as an element having a shaft where one end of the shaft is either connected to a motor (thus serving as a “driver”) or connected to provide an output for the mechanism (thus serving as a “driven element”), while the other end of the shaft attaches to structure for engaging a corresponding aligned element (thus serving as an “actuator”). Similarly, it is somewhat arbitrary as to whether the “actuator” is considered attached to a “driver” or “driven element”, or is considered a part thereof (or, conversely, whether a “driver” or “driven element” is considered a part of the “actuator”). For a given pair of actuators forming a pair of aligned elements, one actuator will be driven to provide an input signal (and thus can be considered attached to, part of, or incorporating a “driver”), while the other is connected to provide an output signal of the mechanism (and thus can be considered attached to, part of, or incorporating a “driven element”).

In some cases, more than one common actuator could be employed, to engage sets of channel actuators; in the examples described in terms of a single common actuator, an analogous mechanism employing multiple common actuators and matching sets of channel actuators should be considered as possible variations.

In some cases, the engagement between an actuator attached to a driver (“driver actuator”) and an aligned actuator attached to a driven element (“driven element actuator”) is accomplished via non-contact forces interacting between the actuators. Non-bonded or non-contact forces (the terms may be used interchangeably herein) include forces such as van der Waals (VDW), the London dispersion force, electrostatic forces, magnetic forces, and forces produced by the Casimir effect. Such forces can be particularly useful in nano-scale and smaller micro-scale mechanisms, where forces such as VDW can create effects not seen in equivalent larger scale mechanisms, allowing relatively simple structures to engage the moving parts. While having particular benefit for nano-scale mechanisms, NCFs that operate a larger scales, such as magnetic attraction or electrostatic attraction, can be employed, and may have particular benefit in modeling the actions of nano-scale mechanisms for purposes of education, research, development, and analysis. While magnetic and/or electrostatic forces may be usable in nano-scale devices, in many cases VDW attraction will still need to be taken into account to assure the proper functioning of a mechanism.

To engage parts via NCFs, the aligned actuators can each be formed with an active surface (i.e., a surface subject to NCF attraction) bounded by at least one effective edge, where the actuators are attracted to each other via NCFs. Such active surface may be provided on an engaging element of the actuator. When the actuators are positioned with their effective edges aligned, motion of the driver actuator causes the driven element actuator to move to stay in alignment with the driver actuator about their axes of rotation (as opposed to the initial alignment of the common actuator and the selected channel actuator to form a pair of aligned elements). Maintaining alignment about the actuators' axes of rotation serves to avoid moving (relatively) any part of the actuators beyond an effective edge of the other, as such motion beyond the edge would require overcoming at least some of the NCF. By staying aligned about their axes of rotation, the actuators remain in an NCF energy well that would require force to move out of. So long as the force required to move out of the NCF energy well and cause misalignment is less stiff than the resistance of the driven element to movement, the driven element moves to keep the driven element actuator in alignment with the driver actuator. In an ideal case, the axes of rotation of the aligned elements are coincident, but the coupling of the actuators via NCF can accommodate a degree of misalignment which does not interfere with effective coupling of the actuators via NCF to cause them to rotate together.

Note that the effective edge is typically where the effects of the NCF between the parts would cause a change, whether or not at a physical edge. For example, in the case of small parts subject to VDW, the effective edge may actually be several Angstroms inside the physical edge, since VDW generally starts to taper off as the edge is approached. In many cases where van der Waals attraction is the primary NCF of concern, an edge may be taken to encompass a distance of about 1 nm or less from the physical edge. In another example, a part may have an edge in a substructure underlying a surface that extends beyond such edge, and the NCF of a part on or near the surface with the underlying edge creates an effective edge on the surface, even if the surface continues beyond such effective edge. Typically, an effective edge is a location on one part where moving another part past such location would require work to overcome the existing degree of NCF between the parts. An edge may also occur between regions of different material, when they differ significantly in their attractive force.

Note that when talking about the strength of VDW between two parts, this refers to magnitude of the NCF (potentially averaged over a distance, as context dictates), regardless of the shape of the NCF curve. Strength is important for calculating work, since work=force×distance. “Stiffness” on the other hand, refers to the change in VDW magnitude over distance. In other words, it is the slope of the NCF curve. A large change in VDW over a short distance gives a stiff force. The same change in VDW over a longer distance requires the same amount of work to overcome but is not as stiff. This is an important distinction because, when two forces oppose each other, it is not the strongest, but rather the stiffest, that prevails. Actuators in a pair of aligned elements may be spaced apart by not more than 3 nm to provide van der Waals attraction between the actuators.

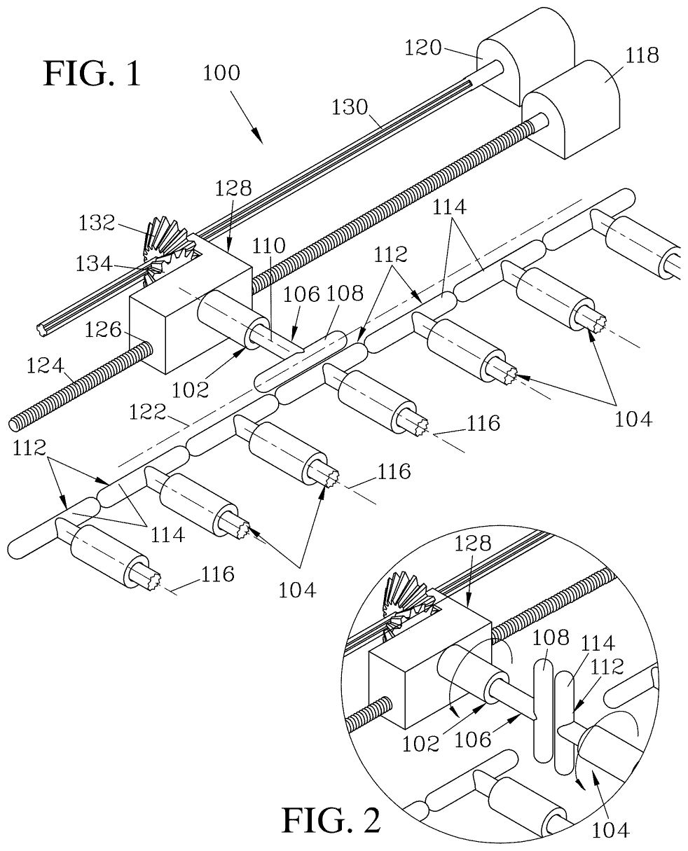

FIGS. 1 and 2 illustrate one example of a selective motion transfer mechanism 100, having a common driver 102 that can be moved to align with any one of a number of driven elements 104 that each defines a channel. In the selective motion transfer mechanism 100, the driven elements 104 are arranged in a linear array, and the driver 102 translates to move between the driven elements 104.

The driver 102 has a common actuator 106, which in this example is formed with an elongated bar that provides a common actuator engaging portion 108, and the common actuator 106 rotates about a common actuator axis 110. Each of the driven elements 104 has a channel actuator 112, also formed with an elongated bar that provides a channel actuator engaging portion 114, and each rotates about an associated channel actuator axis 116. In the linear array shown, the channel actuator axes 116 are parallel to each other and reside in a plane. The driver 102 is moved by two motors, a channel select motor 118 and a signal motor 120. The engaging portions (108, 114) illustrated could be formed from modified CNTs for a nano-scale mechanism, employing van der Waals attraction to engage with each other.

The channel select motor 118 acts to move the driver 102 along a selection axis 122 to position the common actuator 106 opposite a selected one of the channel actuators 112. In this example, the selection axis 122 extends perpendicular to the channel actuator axes 116 and is coplanar therewith. Various mechanisms to provide linear motion of the driver 102 could be employed. In this example, a drive screw 124 that extends parallel to the selection axis 122 engages a threaded passage 126 in a driver block 128, to which the driver 102 is rotatably mounted. The channel select motor 118 rotates the drive screw 124 to change the position of the driver block 128 along the selection axis 122.

When the driver 102 has been positioned with the common actuator 106 aligned with a desired one of the channel actuators 112, such that the common actuator axis 110 is substantially coincident with the channel actuator axis 116 associated with the selected channel actuator 112, the common actuator 106 and the selected channel actuator 112 form a pair of aligned elements. Once a pair of aligned elements is formed, the signal motor 120 can be activated to rotate the common actuator 106. Various mechanisms could be employed to convey rotation from the signal motor 120 to the driver 102. In this example, the signal motor 120 rotates a splined shaft 130, which in turn engages a shaft bevel gear 132 that engages a driver bevel gear 134 that is attached to the driver 102. The shaft bevel gear 132 slides along the splined shaft 130 as the driver block 128 is translated along the selection axis 122, and rotates with the splined shaft 130. Engagement between the shaft bevel gear 132 and the driver bevel gear 134 acts to rotate the driver 102, and in turn rotates the common actuator 106 formed thereon as indicated in FIG. 2.

The common actuator 106 engages the channel actuator 112 that is aligned therewith, causing the channel actuator 112 to rotate with the common actuator 106. In this example, where the selective motion transfer mechanism 100 is designed as a nanoscale mechanism, the engagement between the common actuator 106 and the channel actuator 112 is via non-contact forces (NCFs) such as van der Waals (VDW) forces between the common actuator engaging portion 108 and the channel actuator engaging portion 114. Alternative NCFs could be employed, such as magnetism or electrostatic attraction, particularly for larger scale mechanisms where greater distances between actuators could make the short-range effects of VDW forces negligible (one example employing magnetism is shown in FIG. 19). When the driver 102 rotates the common actuator 106, VDW forces cause the channel actuator 112 to rotate with the common actuator 106 to avoid overcoming the VDW attraction between the actuators (106, 112) that would be required to move their engaging portions (108, 114) out of alignment with each other. Rotational motion is transmitted to the selected driven element 104, and can be thereafter conveyed to whatever further mechanism the driven element 104 is connected to.

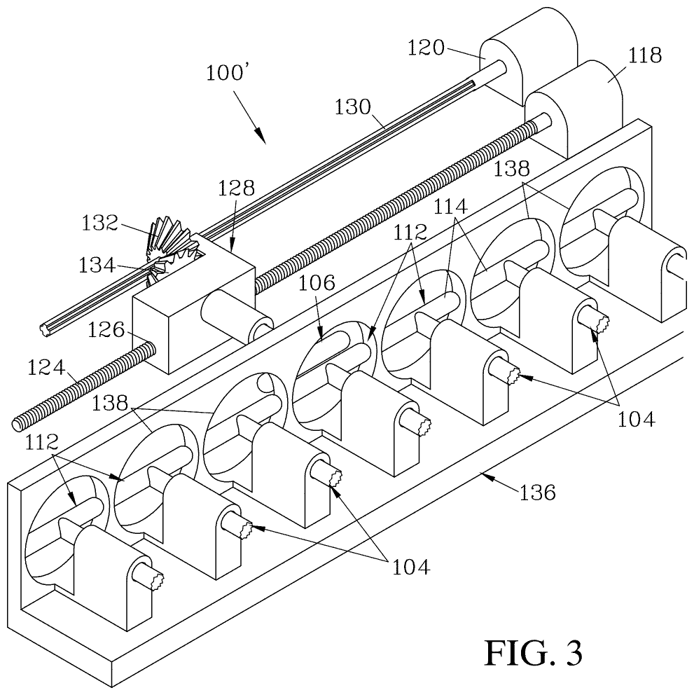

The mechanism 100 can be designed such that the driver 102 rotates in increments of 180°, such that the common actuator 106 and the aligned channel actuator 112 come to rest at positions where the channel actuators 112 are aligned, with each channel actuator engaging portion 114 extending parallel to the selection axis 122 as shown in FIG. 1 (such 180° rotation could be provided by a stepper motor that generates rotation in steps of 60° or 90°). The driver 102 can then be moved by channel selection motor 118 to place the common actuator 106 into opposition to another of the channel actuators 112, without causing misalignment between the common actuator engaging portion 108 and any of the channel actuator engaging portions 114. When moved into opposition to another of the channel actuators 112, forming a new pair of aligned elements, rotation of the driver 102 forces rotation of that driven element 104. When the driven elements 104 are arranged with their channel actuators 112 aligned, the driver 102 can be moved along the channel actuators 112 with only slight resistance; because the channel actuators 112 form a line with only small interruptions, such motion of the driver 102 results in only slight VDW barriers to overcome as the common actuator 106 is moved beyond the edge of one channel actuator 112 and alongside the next. As shown in FIG. 3, a mechanism 100′ can be provided with channel actuators 112 that are rotatably mounted to a body 136, formed with circular openings 138, one for each of the channel actuators 112. The body 136 reduces gaps between the channel actuator engaging portions 118, further reducing changes in VDW force required to move the common actuator 106 from alignment with one channel actuator 112 and into alignment with the next. Similar bodies could be employed for any of the mechanisms described herein, but are typically not shown for greater clarity in illustrating the active parts of the mechanism. Such bodies may be beneficial in allowing increased spacing between the channel actuators to reduce the likelihood of inadvertent motion of those actuators that are adjacent to the aligned pair as one of the aligned pair is rotated. It should be noted that other supporting structure that might be employed to support and position the various elements of the mechanisms with respect to each other is generally omitted in the drawings in order to better illustrate the interaction of the components described in the text.

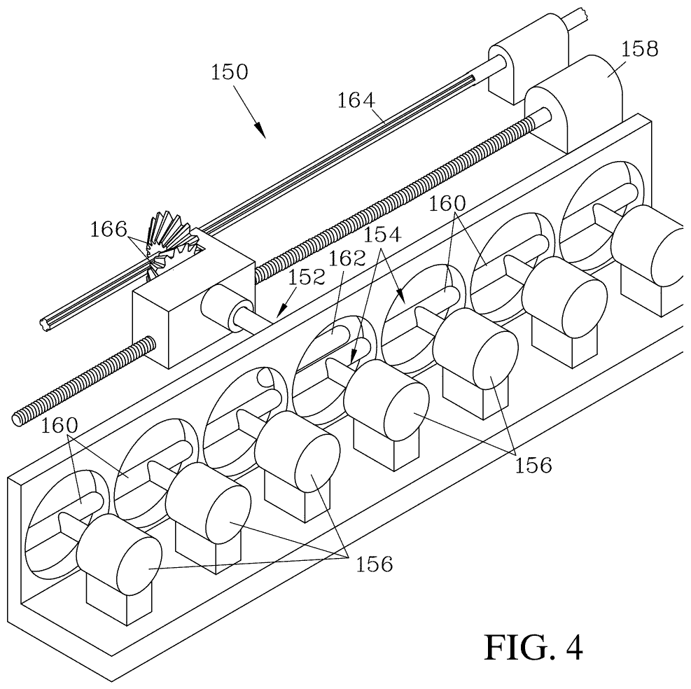

FIG. 4 illustrates a selective motion transfer mechanism 150 where a driven element 152 moves between a number of drivers 154 that are positioned in a parallel array; the mechanism 150 has many elements in common with the mechanism 100 discussed above, and corresponding elements function similarly, except as described. Each of the drivers 154 is rotated by a corresponding signal motor 156, and the driven element 152 is moved into alignment with a selected driver 154 by a channel selection motor 158. Once the driven element 152 is aligned with a desired driver 154, the signal motor 156 for that driver is actuated, and rotates the driven element 152 via the engagement of a channel actuator 160 on the driver 154 and a common actuator 162 on the driven element 152. The rotary motion of the driven element 152 is conveyed to a splined output shaft 164 via a pair of bevel gears 166.

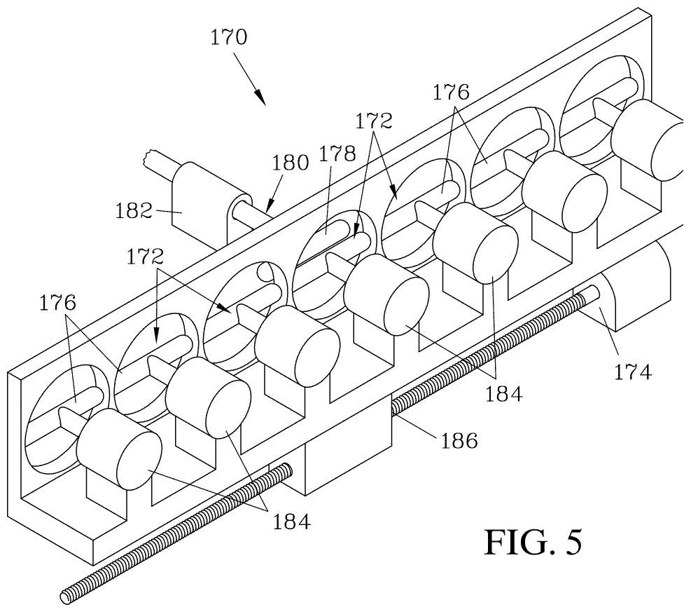

FIG. 5 illustrates an alternative selective motion transfer mechanism 170 in which a linear arrangement of drivers 172 is provided, and the drivers 172 are moved as a group by a channel selection motor 174 to place a selected channel actuator 176 into alignment with a common actuator 178 that is part of a driven element 180. The driven element 180 is rotatably mounted to a fixed block 182. The selected channel actuator 176 is operated by an associated signal motor 184, and drives rotation of the common actuator 178 via VDW attraction. The channel selection motor 174 moves the drivers 172 via a worm gear drive mechanism 186 similar to that shown in FIG. 1.

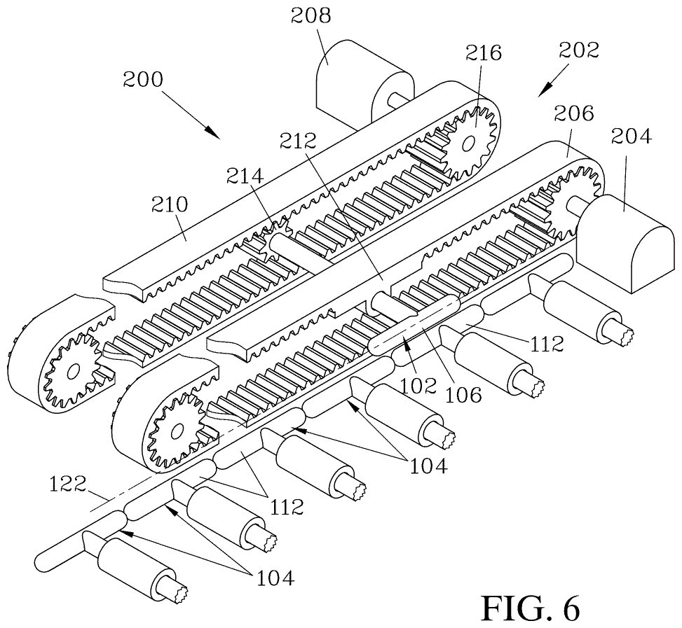

FIG. 6 illustrates a selective motion transfer mechanism 200 which includes many of the elements of the selective motion transfer mechanism 100 discussed above, but where a belt drive mechanism 202 is employed to move the driver 102 between the driven elements 104. The belt drive mechanism 202 is operated by a channel selection motor 204 that drives a selection belt 206, and a signal motor 208 that drives a signal belt 210. The driver 102 is mounted in a drive block 212 that is attached to the channel selection belt 206, and is attached to a drive gear 214 that is driven by the signal belt 210. To align the driver 102 with a desired driven element 104, the channel selection motor 204 is operated to move the drive block 212 along the selection axis 122. At this time, the signal motor 208 can be activated to advance the signal belt 210 at the same speed as the selection belt 206, so that no torque is imparted to the drive gear 214. Once the driver 102 is aligned with the desired driven element 104, the channel selection motor 204 is stopped, and the signal motor 208 drives the signal belt 210 to control rotation of the drive gear 214 and attached driver 102, which again imparts rotation to the driven element 104 via engagement of the common actuator 106 and the channel actuator 112 on the driven element 104. Note that the rotation of the driver 102 relative to rotation of the signal motor 208 can be adjusted by the gear ratio between a signal drive gear 216 (that engages the signal belt 210) and the drive gear 214.

Many of the mechanisms disclosed herein are suitable for nanoscale fabrication. As an example, a belt-driven mechanism similar to that shown in FIG. 6 could be fabricated with a graphene belt, and pulleys or sprockets formed of Lonsdaleite, modified CNTs, and similar materials. In one example, a belt-operated selective motion transfer mechanism having four channels was calculated to have overall dimensions of 41 nm×36 nm×13 nm (excluding motors), with the 41 nm dimension (arbitrarily defined as “width”) determined by the number of outputs; a similar mechanism with 40 channels was calculated to have a width of 225 nm. The dimensions of mechanisms employing screw drives or gear drives are expected to be comparable, providing mechanisms with a volume of 10,000 nm³+2,400 nm³ per channel. Even larger mechanisms, having volumes of 50,000 nm³+12,000 nm³ per channel, 100,000 nm³+24,000 nm³ per channel, 500,000 nm³+120,000 nm³, or 1,000,000 nm³+240,000 nm³ per channel should still provide mechanisms small enough to effectively employ VDW attraction to couple the rotation of actuators that form a pair of aligned elements.

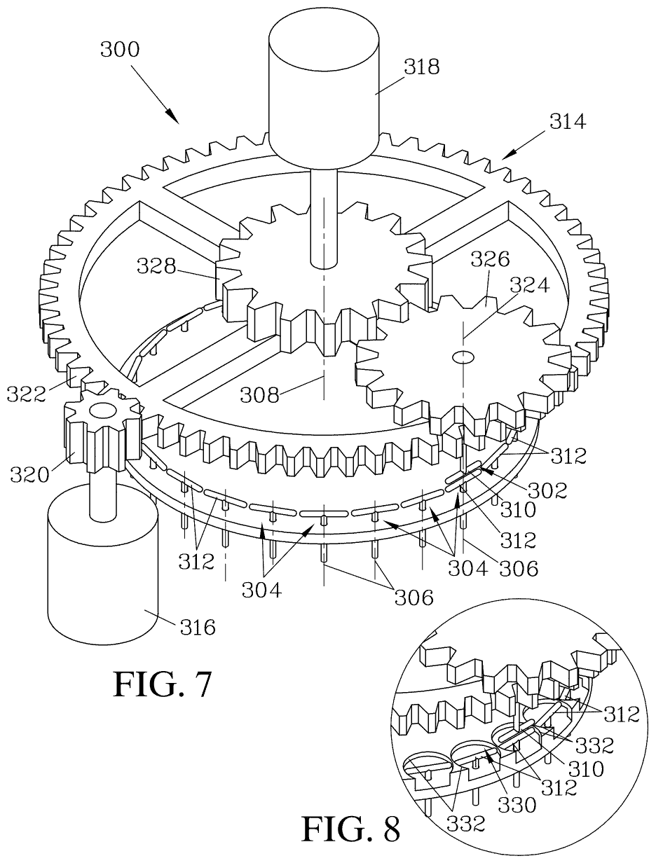

FIG. 7 illustrates a selective motion transfer mechanism 300 where a driver 302 moves between driven elements 304 that are positioned in a radial arrangement, having channel actuator axes 306 that are arranged in a circle about a central axis 308, and which are parallel to each other and to the central axis 308. The driver 302 has a common actuator 310, and each of the driven elements has a channel actuator 312. In this example, the driver 302 is moved by a gear drive mechanism 314, having a channel selection motor 316 and a signal motor 318. Alternatively, the driver could be moved on a circular belt or track, using a mechanism operating similarly to the belt drive of the mechanism 200 discussed above.

The channel selection motor 316 drives a channel selection pinion gear 320 that engages a channel selection central gear 322, which rotates about the central axis 308 and to which the driver 302 is rotatably mounted. Operating the channel selection motor 316 acts to move the driver 302 in a circle or arc about the central axis 308 to place the common actuator 310 into opposition with a selected one of the channel actuators 312. This position aligns a common actuator axis 324 of the driver 302 with the selected channel actuator axis 306. Once in the desired location, the driver 302 can be rotated about the common actuator axis 324 by a driver gear 326, which in turn is driven by a signal motor gear 328 attached to the signal motor 318 and rotating about the central axis 308. To avoid rotation of the driver 302 as the channel selection motor 316 is operated, the signal motor 318 can be operated to turn the driver 302 to match the changing angle as the driver 302 is moved in an arc, keeping the common actuator 310 extending tangent to the arc through which it moves, and thus roughly aligned with each of the channel actuators 312 as the common actuator 310 moves from one channel actuator 312 to the next, reducing the NCF barrier to such movement.

As shown in the partial view of FIG. 8, the NCF barrier to movement from one channel actuator 312 to the next can be further reduced by filling the spaces between the channel actuators 312 by a spacer plate 330 with circular or arcuate apertures 332 in which the channel actuators 312 rotate. The spacer plate 330 serves as a body and acts to reduce the effective gaps between the channel actuators 312, thus reducing the change in NCF attraction that must be overcome to move the common actuator 310 from alignment with one channel actuator 312 to place it into alignment with the next. Similar spacer plates/bodies could be employed to fill the gaps between channel actuators in other selective motion transfer mechanisms.

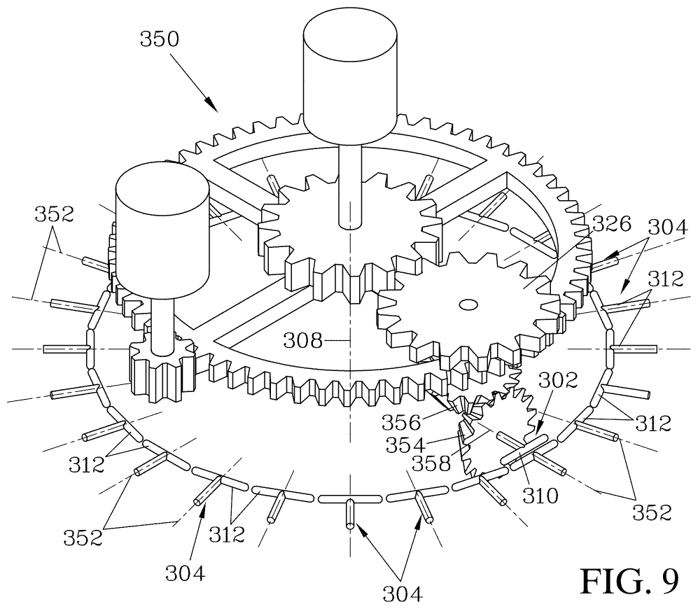

FIG. 9 illustrates a selective motion transfer mechanism 350 which operates in a manner similar to that of the selective motion transfer mechanism 300 and shares many of the same components, but where the driven elements 304 are arranged in a planar radial array about the central axis 308, such that the channel actuators 312 each rotate about a channel actuator axis 352 that intersects and is perpendicular to the central axis 308. The driver 302 is rotated by a bevel driver gear 354, which in turn is driven by a signal motor bevel gear 356 attached to the driver gear 326, so as to rotate the common actuator 310 about a common actuator axis 358 that intersects and is perpendicular to the central axis 308.

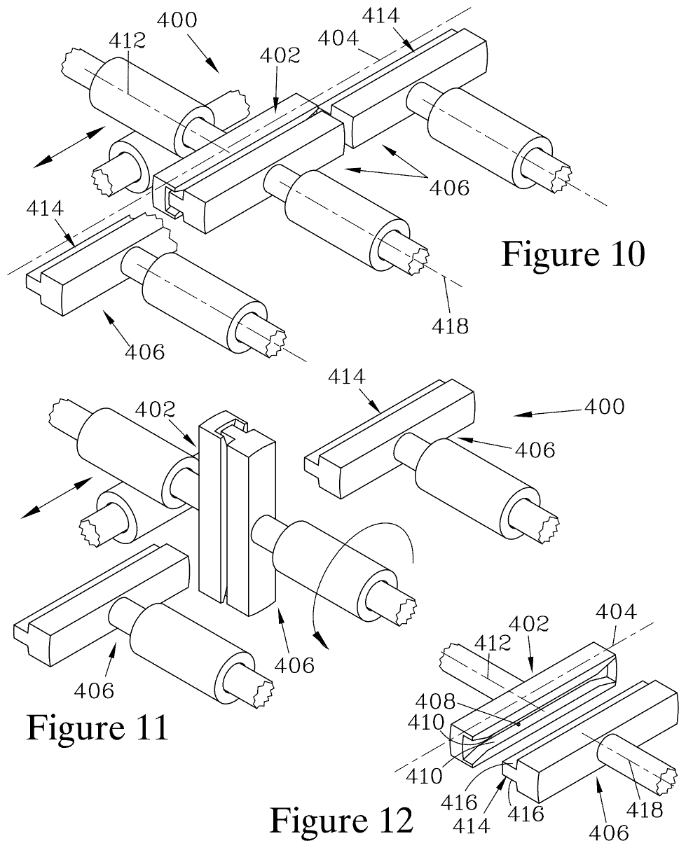

In some mechanisms, matching engaging surfaces on the actuators can be employed to engage them with each other, rather than NCF attraction. The channel actuators should be arranged and configured relative to the common actuator such the engaging surface accommodate the motion to align the common actuator with a selected channel actuator. FIGS. 10 to 12 illustrate a portion of a selective motion transfer mechanism 400 where a common actuator 402 translates along a selection axis 404 to move between a number of channel actuators 406. The mechanism 400 could use a drive mechanism similar to the screw drive of the mechanism 100 or the belt drive of the mechanism 200 to translate the common actuator 402, or could move the channel actuators relative to the common actuator. Either the common actuator 402 or the channel actuators 406 can be driven to rotate by one or more motors. The mechanism 400 differs from the mechanisms discussed above in that it employs a tongue-and-groove interaction between the common actuator 402 whichever one of the channel actuators 406 it is aligned with.

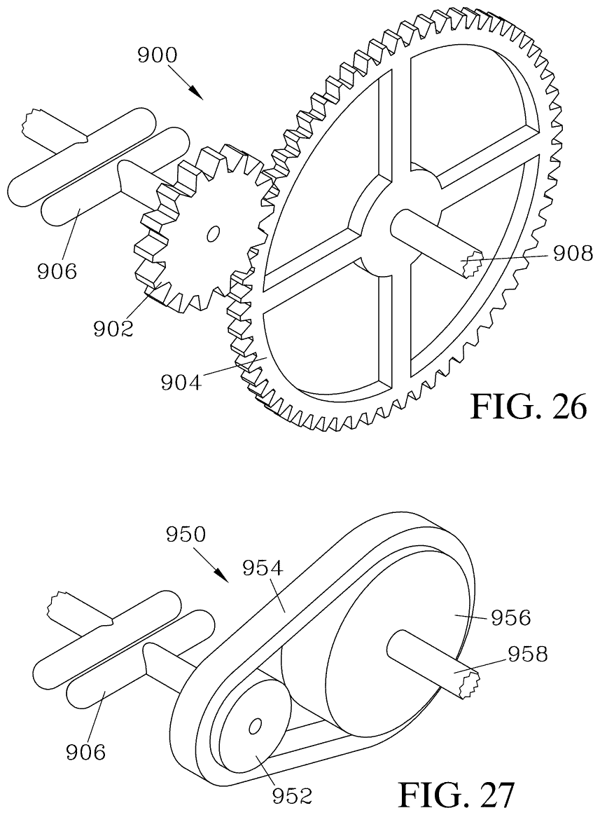

As best shown in FIG. 12, the common actuator 402 is formed with a groove 408, defined by groove surfaces 410 that extend parallel to each other (although having chamfered ends) and perpendicular to a common actuator axis 412, serving as engaging surfaces. The groove surfaces 410 can be aligned parallel to the selection axis 404 (as shown in FIGS. 10 and 12). Each of the channel actuators 406 is formed with a tongue 414, defined by tongue surfaces 416 that serve as engaging surfaces. The tongue surfaces 416 extend parallel to each other and perpendicular to a channel actuator axis 418, and which can be aligned parallel to the selection axis 404. The channel actuators 406 are arranged in a linear array parallel to the selection axis 404, such that the tongue surfaces 416 of all the channel actuators 406 can be aligned parallel with each other (as shown in FIG. 10), allowing the groove 410 on the common actuator 402 to slide along the channel actuator axis 404 between the channel actuators 406. Once the common actuator 402 is aligned with one of the channel actuators 406, forming a pair of aligned elements, rotation of either of the actuators (402, 406) causes the other to rotate, by engagement of the groove surfaces 410 with the tongue surfaces 416 (as shown in FIG. 11). The rotation of whichever actuator (402, 406) is the driven actuator is limited to 180° steps to keep the surfaces (410, 416) aligned with the selection axis 404 after rotation, to allow the common actuator 402 to be moved into alignment with a different one of the channel actuators 406. The 180° steps of rotation could then be converted to a smaller amount of rotation by use of appropriate reduction gears, belts, or other well-known techniques (two examples of reduction mechanisms are shown in FIGS. 26 & 27). The positions of the tongue and groove could be reversed, with the tongue provided on the common actuator and a corresponding groove on each channel actuator.

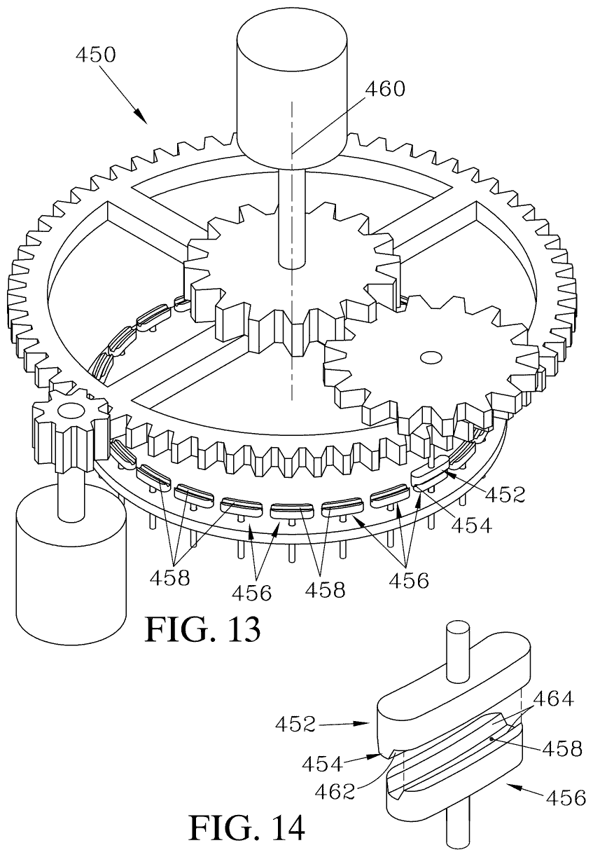

FIGS. 13 and 14 illustrate a selective motion transfer mechanism 450 that has a common actuator 452 having a tongue 454, and channel actuators 456 that each have a groove 458 (as better shown in FIG. 14). The channel actuators 456 are arranged in a radial array about a central axis 460, and the common actuator 452 is moved in a circle or arc about the central axis 460 and selectively rotated, by a mechanism such as the gear drive 314 employed in the mechanism 300 discussed above. The groove 454 and the tongues 458 are defined by engaging surfaces 462, 464 that are surfaces of rotation about the central axis 460.

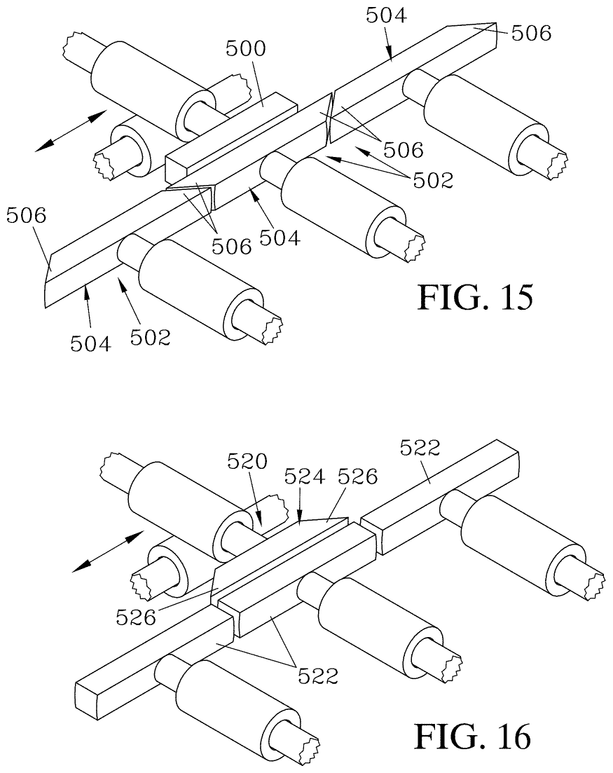

FIGS. 15 to 21 show examples of alternative engaging structures that could be employed for common and channel actuators that engage each other via NCF attraction.

To reduce the VDW force that must be overcome to move the common actuator from alignment alongside one channel to alignment alongside another channel actuator, the geometry of the common actuator and/or the channel actuators could be adjusted to reduce any gaps that create NCF barriers when moving between channel actuators. As one example, FIG. 15 shows a common actuator 500 and several channel actuators 502, where the channel actuators 502 have channel actuator engaging portions 504 with beveled ends 506 such that they overlap portions of the adjacent channel actuator engaging portions 504. As the common actuator 500 is moved between the channel actuators 502, the VDW barrier to movement across the gap between adjacent channel actuator engaging portions 504 is more gradual, and should require less force to overcome the resistance caused by VDW compared to channel actuator engaging portions such as employed in the mechanism 100.

FIG. 16 illustrates another common actuator 520 and channel actuators 522, where the common actuator 520 has a common actuator engaging portion 524 that has beveled ends 526 to provide a more gradual change in VDW forces as the common actuator 520 moves from alignment with one channel actuator 522 into alignment with the next.

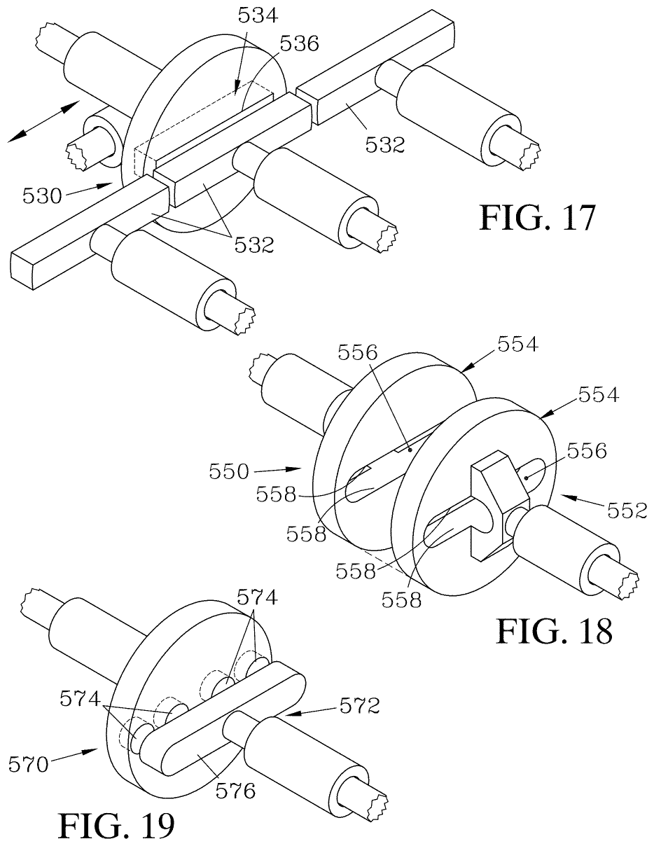

FIG. 17 illustrates a common actuator 530 and several channel actuators 532, where the common actuator 530 is formed as a disk of low-NCF-attractive material, with a bar 534 of a high-NCF-attractive material embedded in the disk. Because the bar 534 has a significantly greater NCF attraction than the remaining material of the common actuator 530, bar edges 536 of the bar 534 serve as effective edges that engage whichever channel actuator 532 is aligned with the common actuator 530, causing the aligned elements (532, 534) to rotate together to avoid the work required to misalign them, which would move portions of the channel actuator 532 beyond the bar edges 536. The channel actuators could similarly be formed as disks with embedded bars of a higher NCF-attractive material. Alternatively, opposed disks of high-NCF-attractive material with embedded bars of low-NCF-attractive material could be employed. While shown extending to the surface of the disk, the bar of high-NCF-attractive material could be recessed below the level of the actual surface.

A similar pair of actuators 550, 552 are illustrated in FIG. 18. Here, each actuator (550, 552) is formed with a disk 554 having an elongated cutout 556. When one of the actuators (550, 552) is rotated, the other rotates with it to maintain the cutouts 556 aligned, to avoid the work required to misalign the cutouts 556. Moving the cutouts 556 into misalignment would require work to move a portion of the disk 554 beyond edges 558 of the cutout 556 on the other actuator (550, 552).

FIG. 19 illustrates actuators 570 and 572, where the actuators (570, 572) employ ferromagnetic attraction to provide the NCF attraction, making them suitable for use in mechanisms at a variety of sizes. The actuator 570 is provided with a row of magnets 574, and the actuator 572 has an actuator engaging portion 576 formed from a ferromagnetically attractive material such as iron or steel that extends parallel to the row of magnets 574.

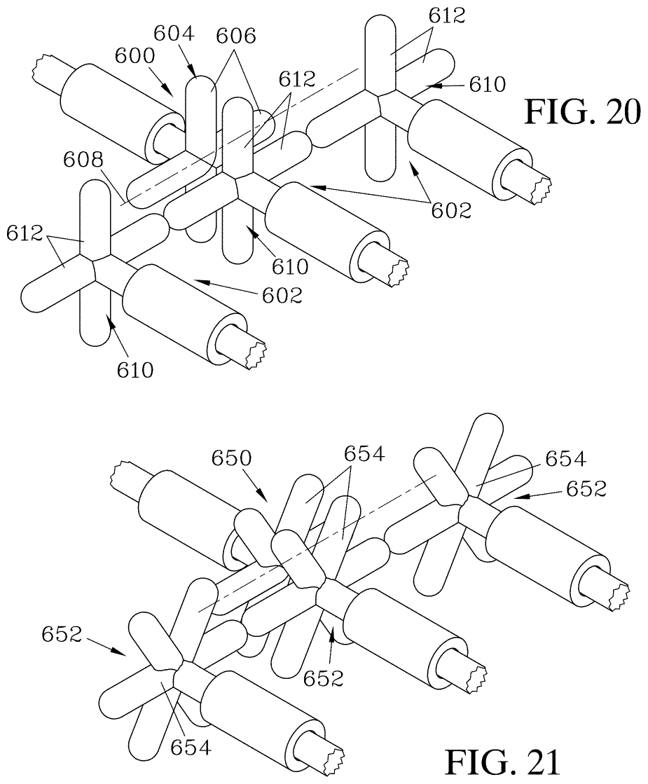

FIG. 20 illustrates a common actuator 600 and several channel actuators 602 that are well suited for transmitting rotational motion in steps of 90°. The common actuator 600 has a common actuator engaging portion 604 that is cross-shaped, with common actuator arms 606 that extend along two perpendicular axes, either one of which can be aligned parallel to a selection axis 608. The channel actuators 602 each have a channel actuator engaging portion 610 that is cross-shaped, with channel actuator arms 612 that extend along two perpendicular axes. When the common actuator 600 is moved from alignment with one channel actuator 602 to alignment with another, the NCF attraction between those arms (606, 612) that are aligned with the selection axis 608 remains relatively constant. However, the NCF attraction between those arms (606, 612) that extend perpendicular to the selection axis 608 does create a significant resistance to motion, and requires work to move the common actuator 600 out of its NCF energy well.

FIG. 21 illustrates a common actuator 650 and channel actuators 652 that each have an engaging portion 654 formed as a 6-pointed star, making them well suited for transferring rotational motion in 60° increments. Similar engaging portions suitable for smaller rotational steps could be employed. However, as the rotational step angle decreases, the risk that a driven element may slip a step increases. Thus, in situations where accuracy is vital, it may be more practical to employ steps of 90° or 180°, and use a reduction mechanism (such as those shown in FIGS. 26 & 27 or functionally equivalent mechanisms) to convert the steps to a smaller angle.

While the examples described above employ planar arrays of channel actuators and a single direction of motion to move the common actuator(s) between channel actuators, a non-planar array of channel actuators could be employed, and may allow a greater number of channels to be accommodated within a smaller overall volume.

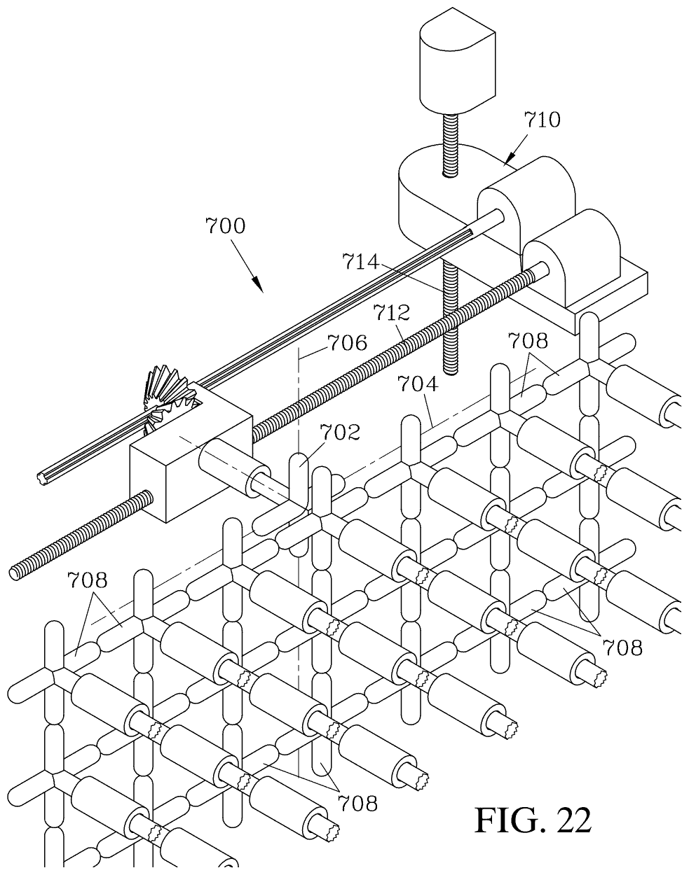

FIG. 22 illustrates a selective motion transfer mechanism 700 having a common actuator 702 that is movable along two selection axes (704, 706) to align with channel actuators 708 that are arranged in a rectangular array. A two-dimensional screw drive mechanism 710 moves the common actuator 702, using a pair of drive screws (712, 714) that extend normal to each other, each providing movement of the common actuator 702 along one of the selection axes (704, 706). While a rectangular array and linear movement is shown, other configurations are possible, such as a spherical arrangement of channel actuators and a drive that moves the common actuator(s) along polar coordinates (i.e., arcuate motion in two directions), or a cylindrical arrangement and a drive that combines arcuate motion (such as provided by the gear drive of the mechanism 350 shown in FIG. 9) with a linear motion along the axis of the cylinder.

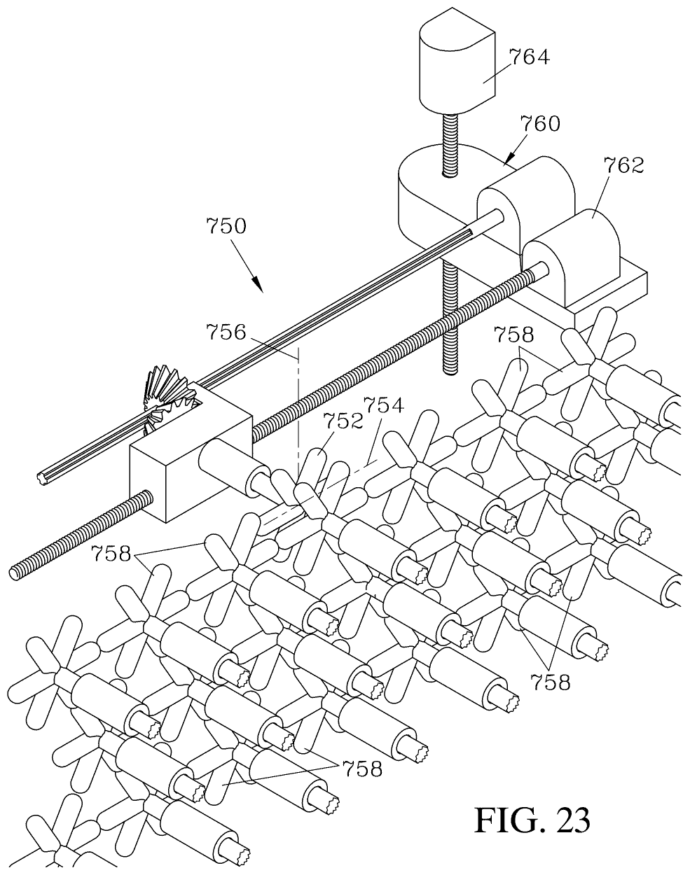

FIG. 23 illustrates a selective motion transfer mechanism 750 that again has a common actuator 752 that moves along two selection axes (754, 756) to align with channel actuators 758, employing a two-dimensional screw drive mechanism 760. However, in the mechanism 750, the channel actuators 758 are arranged in a hexagonal array. The mechanism 750 can operate two channel selection motors (762, 764) in coordination when moving the common actuator 752 between channel actuators 758 that are in different horizontal rows, to allow motion that extends along the arms of the channel actuators 758.

For some uses, a selective motion transfer mechanism may use more than one common actuator, and the common actuators can be selectively aligned with groups of channel actuators. Examples of such uses are when it is desired to provide simultaneous motion in two or three dimensions. For example, where simultaneous motion along both X and Y axes is desired, a common actuator for each axis can be employed, and each channel has an X-axis actuator and a Y-axis actuator. Similarly, three common actuators could provide motion for coordinated 3-dimensional motion. Such mechanisms could be employed in robotic control, where each channel represents a component to be moved, and the individual actuators for that channel represent coordinates for the motion of that component.

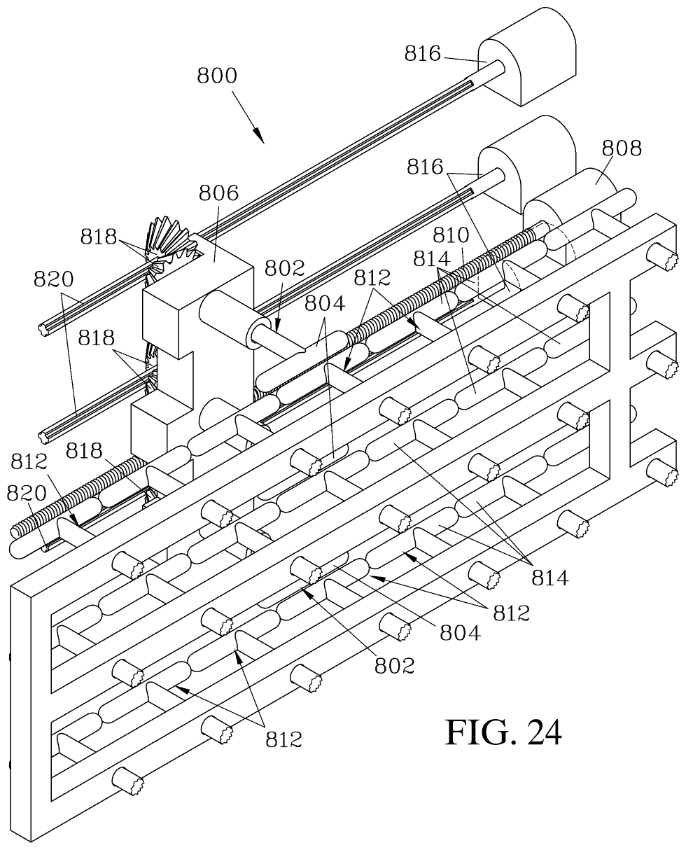

FIG. 24 illustrates a selective motion transfer mechanism 800 that provides a three-part signal to a selected one of multiple channels. The mechanism 800 has three drivers 802, each having a common actuator 804. All three drivers 802 are rotatably mounted to a selection block 806, which is moved by a channel selection motor 808 using a screw drive 810. An array of driven elements 812 is provided, having channel actuators 814 that are arranged in vertical groups of three. The channel selection motor 808 moves the selection block 806 to place the set of three common actuators 804 into alignment with a desired set of three channel actuators 814. At that time, three signal motors 816 can be operated independently to rotate each of the common actuators 804 by a desired amount, via bevel gears 818 and a splined shaft 820 associated with each of the signal motors 816. The outputs of the channel actuators 814 can be redirected as desired via bevel gears or similar means to provide coordinated motion along three axes for a component associated with the selected channel.

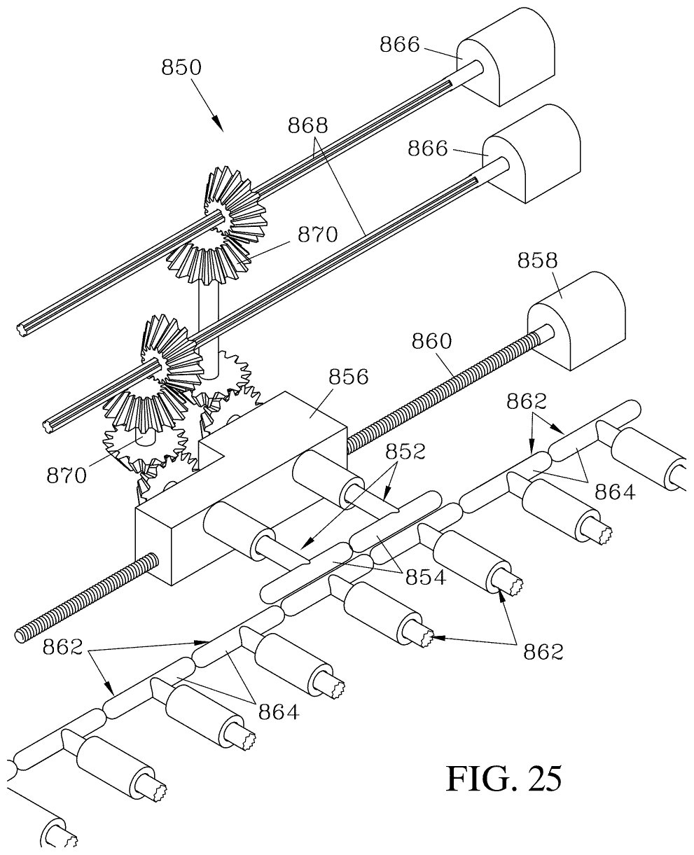

FIG. 25 illustrates a portion of a selective motion transfer mechanism 850 that provides a two-part signal to a selected one of multiple channels. The mechanism 850 has two drivers 852, each having a common actuator 854. Both drivers 852 are rotatably mounted to a selection block 856, which is moved by a channel selection motor 858 via a screw drive 860. A planar array of driven elements 862 is provided, with channel actuators 864 arranged in pairs. The selection block 856 is moved by the channel selection motor 858 to place the pair of common actuators 854 into alignment with a desired pair of channel actuators 864. At that time, the common actuators 854 can each be independently rotated by an associated signal motor 866, each of which can rotate a splined shaft 868. Rotation of the splined shaft 868 is redirected and transmitted to one of the common actuators 854 via a gear train 870 (note that structure attached to the selection block 856 to support the gear trains 870 is not shown to more clearly illustrate the interaction of the parts). Similar gear trains could be employed to redirect the outputs from the channel actuators 864. The output could be employed to provide coordinated motion along two axes of a component associated with the channel that is currently selected; such simultaneous 2-axis motion could be employed in a component that plots a 2-dimensional image, or in additive manufacturing processes that add material in layers.

The selective motion transfer mechanisms described above are intended to accommodate transfer of rotational motion in steps, such as steps of 180°. When it is desired for the output rotation to be in smaller steps, an appropriate reduction mechanism can be employed. Such reduction mechanisms are well known, and substitutes to the examples shown could be employed. Similar mechanisms could be employed to rotate a driver by a desired amount employing a motor that provides an output in different angular rotation steps.

FIG. 26 illustrates a gear reduction mechanism 900 that provides a 4:1 reduction in rotational motion. Thus, if a motion transfer mechanism provides movement of an output in 180° steps, the reduction mechanism 900 could be employed to provide 45° steps. The reduction mechanism 900 has a primary gear 902 with sixteen teeth, that engages a secondary gear 904 with sixty-four teeth, such that each rotation of the primary gear 902 causes ¼ rotation of the secondary gear 904. If the primary gear 902 is driven by the driven element 906 of a selective motion transfer mechanism, the secondary gear 904 provides an output rotation to a reduction output shaft 908 that is ¼ the rotation of the driven element 906. While simple toothed gears (902, 904) are shown, alternative configurations such as worm gears, bevel gears, planetary gears, etc., could be employed.

FIG. 27 illustrates a belt reduction mechanism 950 that provides a 2:1 reduction in rotational motion. The reduction mechanism 950 has a primary pulley 952 that can be driven by a driven element 906 of a selective motion transfer mechanism. The primary pulley 952 engages a belt 954, which in turn engages a secondary pulley 956 that has a radius twice that of the primary pulley 952. Thus, each rotation of the primary pulley 952 causes ½ rotation of the secondary pulley 956, and thus each rotation of the driven element 906 results in ½ rotation of a reduction output shaft 958 attached to the secondary pulley 956. While a simple belt and pulleys are shown, other configurations could be employed, such as a toothed belt and matching pulleys or pulleys with sprockets and a matching belt.

The above discussion, which employs particular examples for illustration, should not be seen as limiting the spirit and scope of the appended claims.

What is claimed is:

1. A selective motion transfer mechanism comprising:
a plurality of channel actuators, each rotatable about an associated channel actuator axis;
a common actuator rotatable about a common actuator axis,
said common actuator and said channel actuators being movable with respect to each other such that said common actuator can be placed into alignment opposite a selected one of said channel actuators,
said common actuator and each of said channel actuators being configured such that, when said common actuator is aligned with one of said channel actuators, forming a pair of aligned elements, rotation of one of said aligned elements acts on the other of said aligned elements via non-contact forces to transfer rotational movement thereto; and
a driver that drives rotation of one of said aligned elements.

2. The selective motion transfer mechanism of claim 1 wherein each of said channel actuators has a channel actuator engaging portion that extends radially from the channel actuator axis, and
said common actuator has a common actuator engaging portion that extends radially from the common actuator axis, said common actuator engaging portion being superimposable over and substantially parallel to said channel actuator engaging portion of a channel actuator with which said common actuator is aligned, such that non-contact forces between said engaging portions serve to transfer motion between said aligned elements.

3. The selective motion transfer mechanism of claim 2 wherein said common actuator engaging portion and any one of said channel actuator engaging portions can be oriented such that motion between said common actuator and said channel actuator to bring said common actuator and said channel actuator into and out of alignment can occur parallel to said common actuator engaging portion and said channel actuator engaging portion.

4. The selective motion transfer mechanism of claim 3 wherein said channel actuator axes reside in a common plane.

5. The selective motion transfer mechanism of claim 4 wherein said channel actuator axes are arranged in a parallel array, and said common actuator translates with respect to said channel actuators along a selection axis to move into and out of alignment with said channel actuators.

6. The selective motion transfer mechanism of claim 4 wherein said channel actuator axes are arranged in a radial array, and said common actuator rotates with respect to said channel actuators about a central axis to move into and out of alignment with said channel actuators.

7. The selective motion transfer mechanism of claim 2 wherein said channel actuator axes are arranged in a radial array and extend parallel to each other, and said common actuator rotates with respect to said channel actuators about a central axis to move into and out of alignment with said channel actuators.

8. The selective motion transfer mechanism of claim 2 wherein said channel actuators are all rotatably mounted to a body, and said body has a spacer structure that fills in the spaces between said channel actuators.

9. The selective motion transfer mechanism of claim 1 wherein the actuators that form said pair of aligned elements are spaced apart from each other by not more than 3 nm.

10. The selective motion transfer mechanism of claim 1 wherein at least one of said actuators has beveled ends.

11. The selective motion transfer mechanism of claim 1 having at least two common actuators.

12. A selective motion transfer mechanism comprising:
a plurality of channel actuators, each rotatable about an associated channel actuator axis;
a common actuator rotatable about a common actuator axis,
said common actuator and said channel actuators being movable with respect to each other such that said common actuator can be placed into alignment opposite a selected one of said channel actuators so as to align the common actuator axis with the channel actuator axis of said selected one of said channel actuators,
said common actuator and each of said channel actuators being configured such that, when said common actuator is aligned with one of said channel actuators, forming a pair of aligned elements, rotation of one of said aligned elements acts on the other of said aligned elements to transfer rotational movement thereto,
said aligned elements being further configured such that they can be brought into and out of alignment by unidirectional movement of said common actuator relative to said channel actuators; and
a driver that drives rotation of one of said aligned elements.

13. The selective motion transfer mechanism of claim 12 wherein said aligned elements engage each other via non-contact forces.

14. The selective motion transfer mechanism of claim 12 wherein said aligned elements engage each other via engaging surfaces.

15. The selective motion transfer mechanism of claim 14 wherein said channel actuator axes are arranged in a parallel array and said common actuator translates with respect to said channel actuators along a selection axis to move into and out of alignment with said channel actuators.

16. The selective motion transfer mechanism of claim 14 wherein said channel actuator axes are arranged in a radial array, and said common actuator rotates with respect to said channel actuators about a central axis to move into and out of alignment with said channel actuators.

17. A method of transferring motion comprising the steps of:
providing a plurality of channel actuators, each rotatable about an associated channel actuator axis;
providing a common actuator rotatable about a common actuator axis;
moving the common actuator relative to the channel actuators to place the common actuator into alignment opposite a selected one of the channel actuators to form a pair of aligned elements; and
rotating one of the aligned elements,
wherein the common actuator and each of the channel actuators are configured such that rotation of one of the aligned elements acts on the other of the aligned elements via non-contact forces to transfer rotational movement thereto.

18. The method of claim 17 wherein said step of moving the common actuator relative to the channel actuators includes translating one of the common actuator and the plurality of channel actuators along an axis perpendicular to the channel actuator axes.

19. The method of claim 17 wherein said step of moving the common actuator relative to the channel actuators includes rotating one of the common actuator and the plurality of channel actuators about a central axis that is perpendicular to the channel actuator axes.

20. The method of claim 17 wherein said step of moving the common actuator relative to the channel actuators includes rotating one of the common actuator and the plurality of channel actuators about a central axis that is parallel to the channel actuator axes.
